(19) United States
(12) Patent Application Publication
(10) Pub. No.: US 2013/0100097 A1
(43) Pub. Date: Apr. 25, 2013

(54) DEVICE AND METHOD OF CONTROLLING LIGHTING OF A DISPLAY BASED ON AMBIENT LIGHTING CONDITIONS

(71) Applicant: Russel Allyn Martin, Menlo Park, CA (US)

(72) Inventor: Russel Allyn Martin, Menlo Park, CA (US)

(73) Assignee: QUALCOMM MEMS TECHNOLOGIES, INC., San Diego, CA (US)

(21) Appl. No.: 13/278,516

(22) Filed: Oct. 21, 2011

(51) Int. Cl. G06F 3/038; H05B 37/02

(52) U.S. Cl. 345/207; 315/158

(57) ABSTRACT

This disclosure provides systems, methods and apparatus, including computer programs encoded on computer storage media, for controlling lighting of a display based on ambient light conditions. In one aspect, a display device can include a display and an auxiliary light source configured to provide supplemental light to the display. The display device further can include a sensor system configured to measure a diffuse illuminance of ambient light from a wide range of directions and configured to measure a directed illuminance of the ambient light from a relatively narrow range of directions. The display device further can include a controller configured to adjust the auxiliary light source to provide an amount of supplemental light to the display. The amount of supplemental light can be based at least in part on the measured directed illuminance and the measured diffuse illuminance of the ambient light.

### TECHNICAL FIELD

This disclosure relates to devices and methods of controlling lighting of a display based on ambient lighting conditions.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Interferometric modulators and conventional liquid crystal elements can be included into a reflective or transflective displays that can use ambient light as a light source. Sensors can detect the illuminance of the ambient light and adjust an auxiliary light source accordingly. However, the image displayed on a display can be affected not only by the overall illuminance, but also by the direction of the ambient light.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display device. For example, the display device can include a display, an auxiliary light source, a sensor system, and a controller. The auxiliary light source can be configured to provide supplemental light to the display. The sensor system can be configured to measure a diffuse illuminance of ambient light from a wide range of directions. The sensor system also can be configured to measure a directed illuminance of the ambient light from a relatively narrow range of directions. The controller can be in communication with the sensor system and configured to adjust the auxiliary light source to provide an amount of supplemental light to the display. The amount of supplemental light can be based at least in part on the measured directed illuminance and the measured diffuse illuminance of the ambient light.

In various implementations, the display device can include a reflective display, for example, having interferometric modulators. In some implementations, the sensor system can include at least one sensor configured to sense ambient light from at least two directions. For example, the at least one sensor can include a diffuse light sensor configured to measure the diffuse illuminance and a directed light sensor configured to measure the directed illuminance. As another example, the at least one sensor can include a plurality of directed light sensors. In these such implementations, each directed light sensor can be configured to measure illuminance of the ambient light received within a solid angle around a direction. The solid angle can be substantially less than 2π steradians.

In various implementations of the display device, the controller can be configured to adjust the auxiliary light source based at least in part on a ratio of the measured directed illuminance to the measured diffuse illuminance. In some implementations, the controller can be configured to adjust the auxiliary light source based at least in part on a sum of the measured directed illuminances and the measured diffuse illuminance. Furthermore, the controller can be configured to adjust the auxiliary light source based on a direction to a directed ambient light source and/or based at least in part on a location of a viewer. The direction to the directed ambient light source can be determined based at least in part on the directed illuminance and the diffuse illuminance measured by the sensor system.

In some implementations, the display device also can include a processor, for example, to process image data, and a memory device. The processor can be configured to communicate with the display, and the memory device can be configured to communicate with the processor. Certain implementations of the display device further can include a driver circuit configured to send at least one signal to the display. The display device also can include a driver controller configured to send at least a portion of the image data to the driver circuit. In addition, the display device can include an image source module configured to send the image data to the processor. The image source module can include at least one of a receiver, transceiver, and transmitter. Furthermore, the display device can include an input device configured to receive input data and to communicate the input data to the processor.

Another innovative aspect of the subject matter described in this disclosure can be implemented in a display device including means for displaying an image, means for providing auxiliary light to the means for displaying an image, means for sensing ambient light, and means for controlling the means for providing auxiliary light. The means for sensing ambient light can be configured to measure a diffuse illuminance of the ambient light from a wide range of directions and configured to measure a directed illuminance of the ambient light from a relatively narrow range of directions. The means for controlling the means for providing auxiliary light can be configured to adjust the means for providing auxiliary light based at least in part on the measured directed illuminance and the measured diffuse illuminance of the ambient light.

In various implementations of the display device, the means for displaying an image includes a reflective display. The reflective display can include interferometric modulators. In certain implementations, the means for providing auxiliary light can include a front-light. In some implementations, the means for sensing ambient light can include at least one sensor configured to sense ambient light from at least two directions. For example, the at least one sensor can include a diffuse light sensor configured to measure the diffuse illuminance and a directed light sensor configured to measure the directed illuminance. As another example, the at least one sensor can include a plurality of directed light sensors. Each directed light sensor in these examples can be configured to measure illuminance of the ambient light received within a solid angle around a direction. The solid angle can be substantially less than 2π steradians.

In some implementations, the means for controlling the means for providing auxiliary light can be configured to adjust the means for providing auxiliary light based at least in part on a ratio of the measured directed illuminance to the measured diffuse illuminance. In some implementations, the means for controlling the means for providing auxiliary light can be configured to adjust the means for providing auxiliary light based at least in part on a sum of the measured directed illuminances and the measured diffuse illuminance. The means for controlling the means for providing auxiliary light further can be configured to adjust the means for providing auxiliary light based on a direction to a directed ambient light source and/or based on a location of a viewer.

Another innovative aspect of the subject matter described in this disclosure can be implemented in a method of controlling lighting of a display of a display device. The display device can have an auxiliary light source configured to provide supplemental light to the display. The display device can have a diffuse light sensor and a directed light sensor. As an example, the method can include measuring a diffuse illuminance of ambient light from a wide range of directions, measuring a directed illuminance of the ambient light from a relatively narrow range of directions, and adjusting the auxiliary light source based at least in part on the measured directed illuminance and the measured diffuse illuminance of the ambient light. Measuring a diffuse illuminance from a wide range of directions can be, for example, by the diffuse light sensor. Measuring a directed illuminance from a relatively narrow range of directions can be, for example, by the directed light sensor. Adjusting can be, for example, by execution of instructions by a hardware processor. In some implementations, adjusting the auxiliary light source can include adjusting the auxiliary light source based at least in part on a ratio of the measured directed illuminance to the measured diffuse illuminance. In some implementations, adjusting the auxiliary light source can include adjusting the auxiliary light source based at least in part on a sum of the measured directed illuminances and the measured diffuse illuminance. In some implementations, adjusting the auxiliary light source can be based on a direction to a directed ambient light source and/or based on a location of a viewer.

Another innovative aspect of the subject matter described in this disclosure can be implemented in a non-transitory tangible computer storage medium having stored thereon instructions for controlling lighting of a display device. The instructions, when executed by a computing system, can cause the computing system to perform operations. As an example, the operations can include receiving from a computer-readable medium a measurement of a directed illuminance of ambient light from a relatively narrow range of directions, receiving from a computer-readable medium a measurement of a diffuse illuminance of ambient light from a wide range of directions, and determining additional lighting conditions based at least in part on the measurement of the directed illuminance and the measurement of the diffuse illuminance of the ambient light. The operations further can include transmitting a lighting adjustment based at least in part on the additional lighting conditions to a light source configured to provide light to the display.

In certain implementations of the non-transitory tangible computer storage medium, receiving the diffuse illuminance of ambient light can include receiving a plurality of directed illuminances for different directions. Also, in some implementations, determining additional lighting conditions can include accessing a lookup table that correlates diffuse illuminance with a ratio of directed illuminance to the diffuse illuminance. In some other implementations, determining additional lighting conditions can include accessing a formula that correlates diffuse illuminance with a ratio of directed illuminance to the diffuse illuminance. Additionally, in some implementations, determining additional lighting conditions can include accessing a formula that is based at least in part on a sum of the measured directed illuminances and the measured diffuse illuminance.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A illustrates an example of specular reflectance on a display surface.

FIG. 9B illustrates an example of Lambertian reflectance on a display surface.

FIG. 9C illustrates an example of a reflective display surface illuminated with diffuse lighting.

FIG. 9D illustrates an example of reflectance in-between specular reflectance and Lambertian reflectance.

FIG. 10 illustrates an example of directed lighting at a high angle and above the viewer.

FIG. 11 is a graphical diagram of the brightness of a display as a function of the angle of view off the specular direction for examples of displays with high gain, low gain, and Lambertian characteristics.

FIG. 12 illustrates an example implementation of a display device.

FIG. 13A illustrates an example sensor system that includes a diffuse light sensor and a directed light sensor.

FIG. 13B illustrates an example of an acceptance angle, θ_{acc}, for an example directed light sensor.

FIG. 13C illustrates an example sensor system that includes a plurality of directed light sensors.

FIG. 13D illustrates an example sensor system that includes a single directed light sensor.

FIG. 14A shows example experimental results and an example illumination model for an example display device.

FIG. 14B shows example experimental results and an example illumination model for an example reflective display device that appears relatively bright compared to a reflective display device without use of a front-light source.

FIG. 15A illustrates an example lookup table that can be used in some implementations to determine an amount of supplemental light to add to a display device.

FIG. 15B is a graphical diagram of the relative intensity (in arbitrary units) as a function of the angle of view off the specular direction for a display device with gain.

FIG. 16 illustrates two example illumination models for an emissive display device.

FIG. 17A illustrates an example method of controlling lighting of a display.

FIG. 17B illustrates another example method of controlling lighting of a display.

FIGS. 18A and 18B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

In some implementations, a display device can be fabricated using a display and a plurality of display elements such as spatial light modulating elements (e.g., interferometric modulators). The display device can use ambient light as a light source such that the image displayed on the display can be affected by the direction and/or the illuminance of the ambient light. By using an auxiliary light source to provide illumination to at least some of the display elements, the image displayed can become brighter under certain lighting conditions. The display device of various implementations can include a sensor system to measure a diffuse illuminance of the ambient light from a wide range of directions and/or to measure a directed illuminance of the ambient light from a relatively narrow range of directions. A controller of the display device can adjust the auxiliary light source to provide additional illumination (e.g., above the ambient lighting conditions) to at least some of the display elements based at least in part on the measured directed and/or diffuse illuminances.

Particular implementations of the subject matter described in this disclosure can be used to realize one or more of the following potential advantages. For example, various implementations are configured to produce a brighter image on a display. The display device can determine how much, if any, additional lighting can be added to the display device based at least in part on the diffuse and/or directed illuminances of the ambient light. In various implementations, the display device also can determine how much additional lighting can be added based on the direction of the ambient light. In further implementations, the display device can determine how much additional lighting can be added based on a measured, assumed, or estimated location of the viewer of the device. Various implementations also may allow optimization of power usage and brightness of the display device and may provide energy efficient devices.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

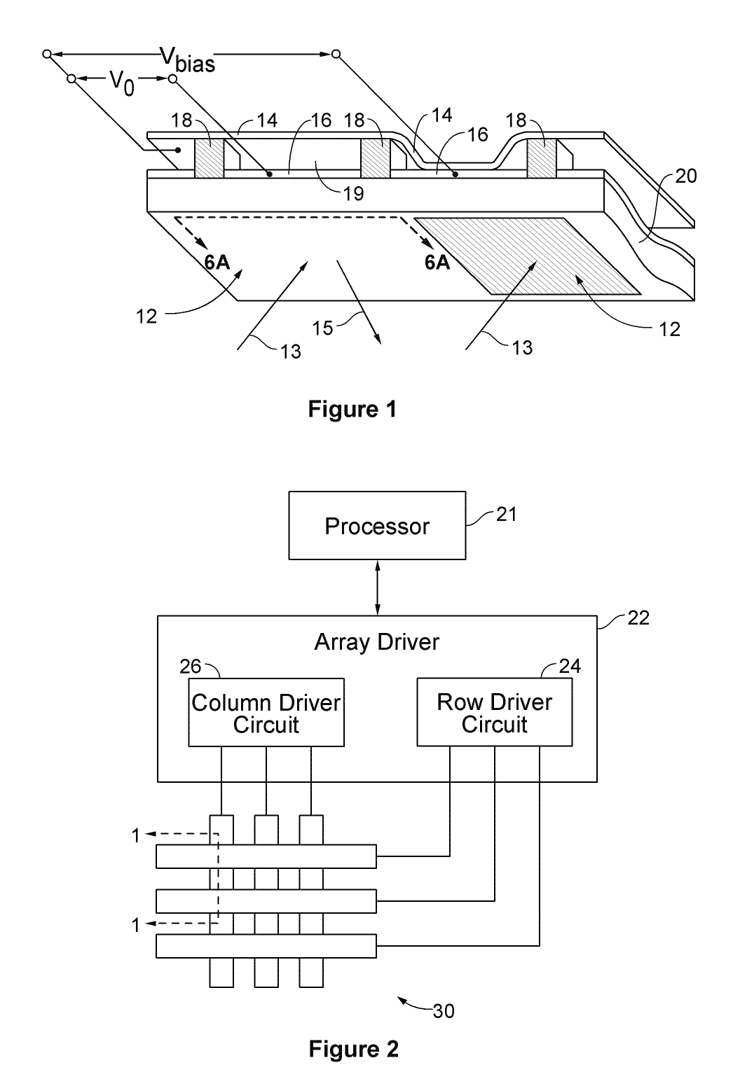

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 6, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

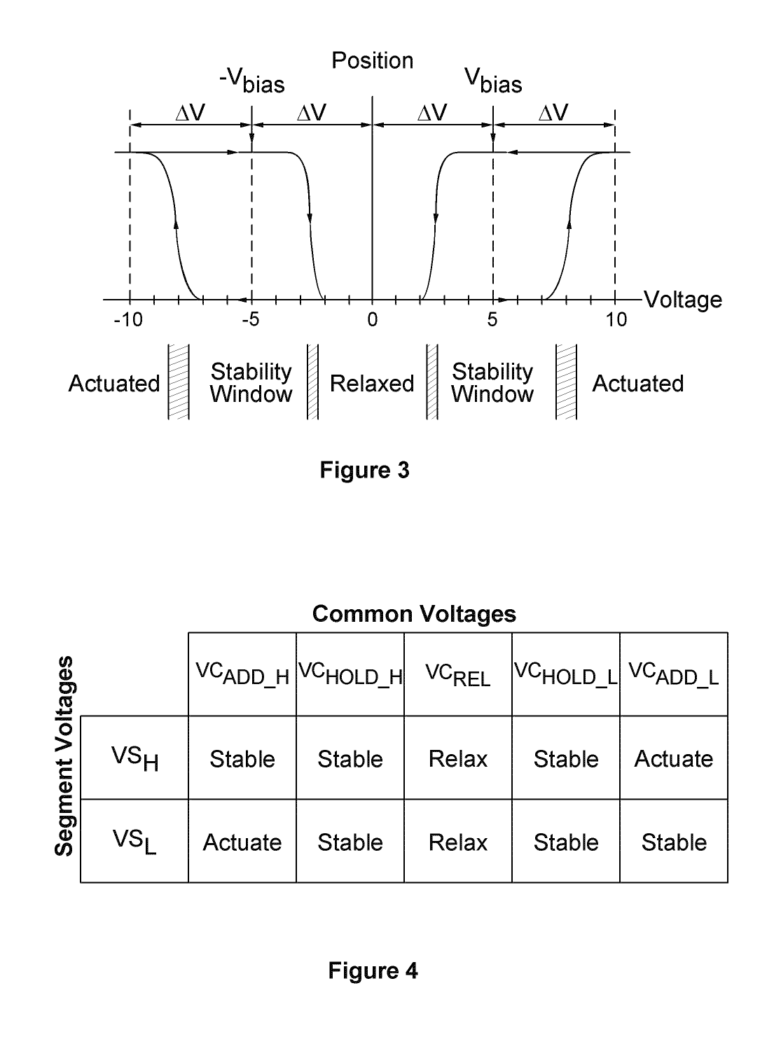

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

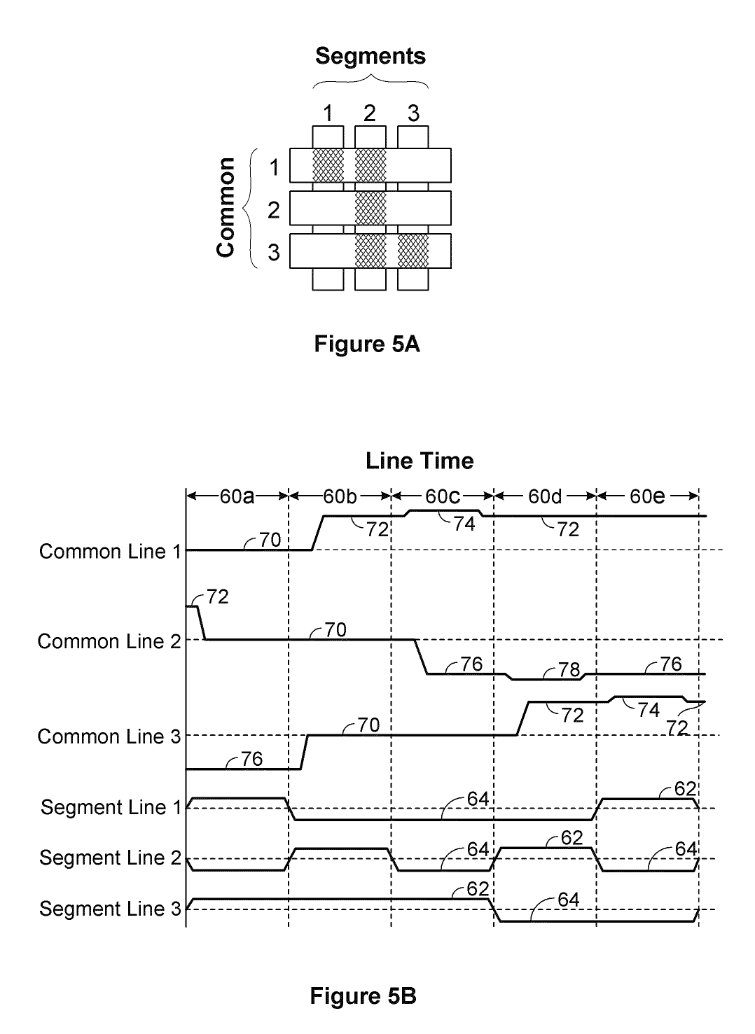

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VD_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

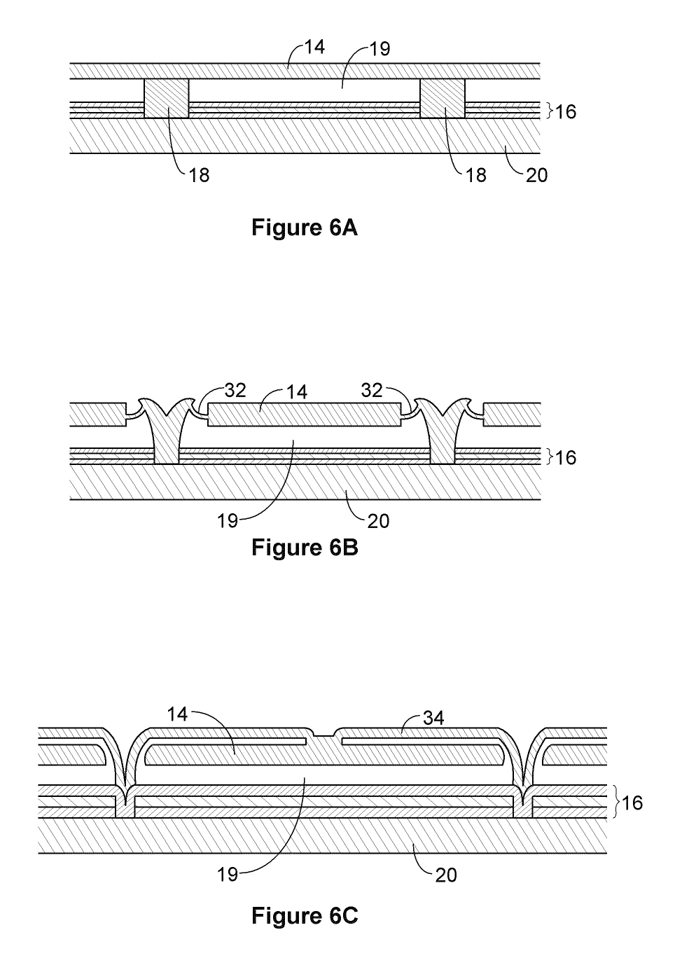

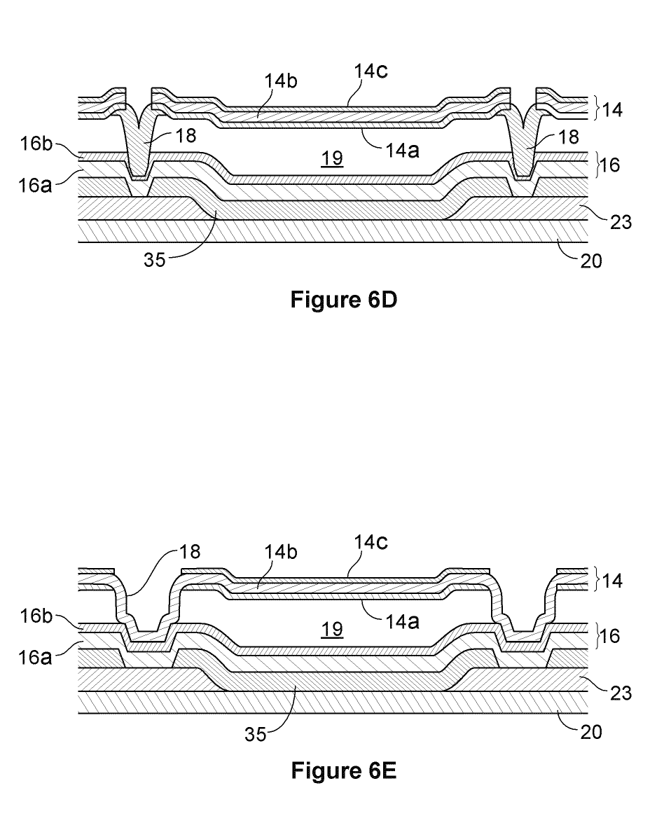

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO_{2 tri-layer stack. Either or both of the reflective sub-layer 14}a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a spacer layer (e.g., SiO₂), and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

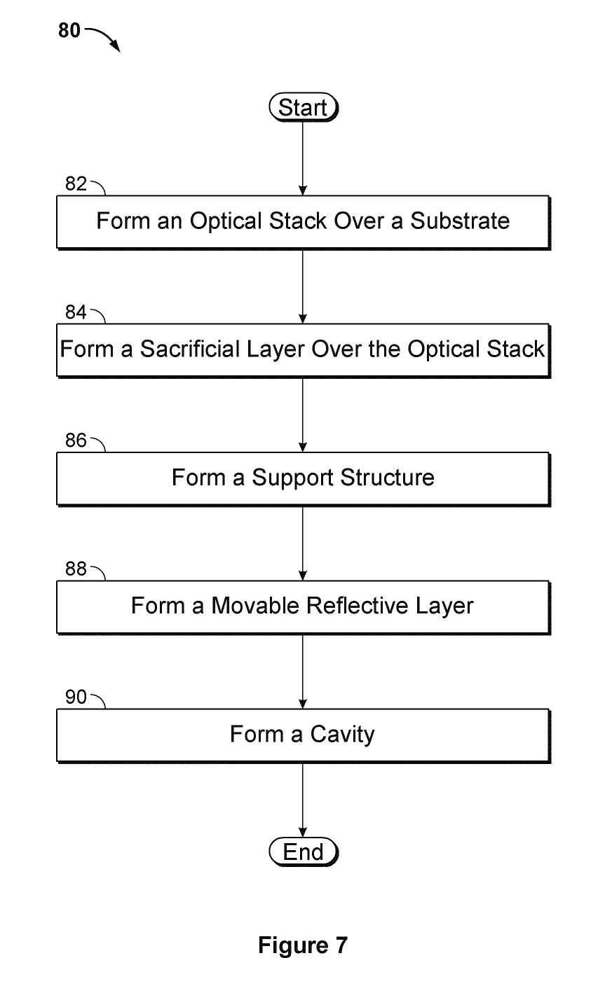

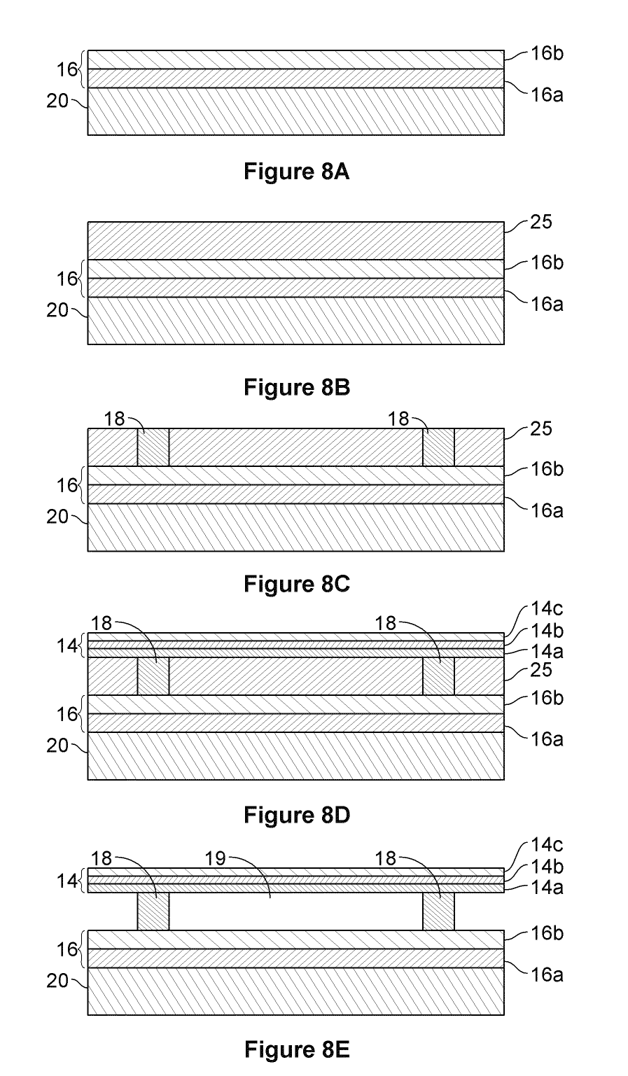

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

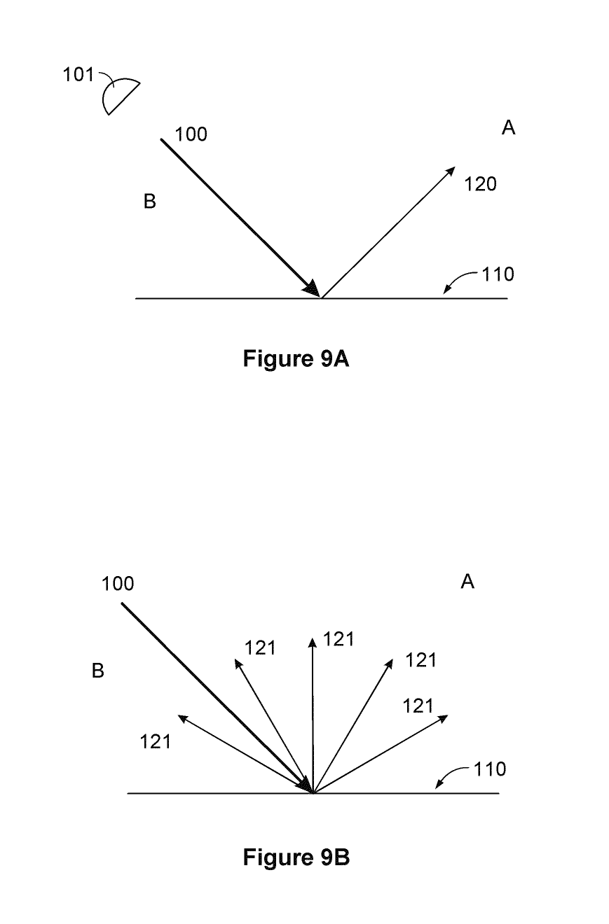

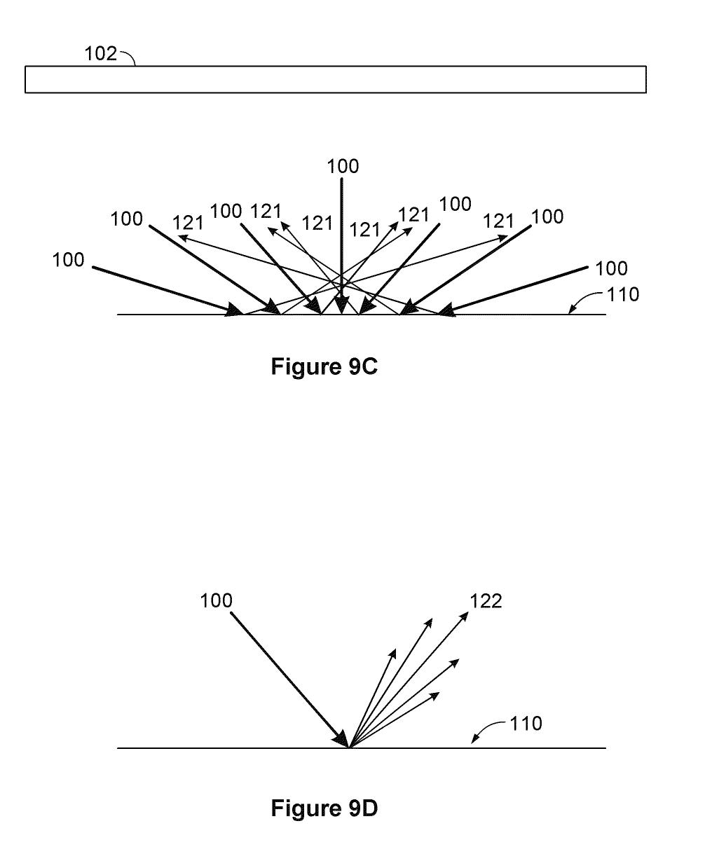

Because reflective displays, e.g., some displays including interferometric modulators, may be specular reflective displays and can use ambient light as a light source, the image displayed can be affected by the direction and/or illuminance of the ambient light. FIG. 9A illustrates an example of specular reflectance on a display surface. In specular reflectance, the incoming light 100 from directed lighting 101 (e.g., directional light coming from one or more light sources such as the sun, a room light, etc.) is reflected from the display surface 110 in a single direction 120. The reflectance from the display surface 110 can appear the brightest in the direction 120 of specular reflectance. Because incoming light 100 is reflected in a certain direction 120 under directed lighting 101, the specular reflective display can look different in different directions. For example, when a viewer looks at the display surface 110 from point A (direction 120 of specular reflectance), the display surface 110 can appear relatively bright. However, when a viewer looks at the display surface 110 at point B (not in a direction 120 of specular reflection), the display surface 110 can appear relatively dim.

FIG. 9B illustrates an example of Lambertian reflectance on a display surface 110. In Lambertian reflectance, the incoming light 100 is reflected from the display surface 110 in substantially all directions 121 and the apparent brightness of the display surface 110 appears substantially the same regardless of the angle of view. For example, the display surface 110 has substantially the same brightness when observing the display surface 110 from point A or from point B.

FIG. 9C illustrates an example of a reflective display surface 110 illuminated with diffuse lighting 102. As illustrated in FIG. 9C, when the reflective display surface 110 is illuminated with diffuse lighting 102 (e.g., light coming from substantially all directions above the surface 110), the incoming diffuse light 100 is reflected in substantially all directions 121 and thus, the brightness of the display surface 110 may look substantially the same in all directions (above the display surface 110) regardless of the viewer's location (e.g., the reflective display has Lambertian reflectance characteristics under diffuse lighting conditions). For certain implementations, all directions above the display surface 110 can include a range of solid angles up to and including 2π steradian. A steradian can be defined as the solid angle subtended at the center of a unit sphere by a unit area on the unit sphere's surface. A sphere subtends a solid angle of 4π steradian. Thus, all directions above the display surface 110 can have a solid angle of up to about half a sphere, e.g., up to and including 2π steradian.

Reflective displays also can exhibit characteristics in-between specular reflectance and Lambertian reflectance. FIG. 9D illustrates an example of reflectance in-between specular reflectance and Lambertian reflectance. As shown in FIG. 9D, the incoming light 100 scatters or reflects at a range of angles around a direction 122 (which may in some implementations be the specular direction). A surface 110 also can have a combination of the reflectance characteristics illustrated in FIGS. 9A-9D, e.g., reflectance from a surface 110 under diffuse and directed lighting conditions. The appearance (e.g., brightness) of the surface 110 can depend on factors including the amount(s) of diffuse and directed lighting, the angle(s) from which the directed lighting is received by the surface, the direction at which the surface 110 is viewed, and so forth.

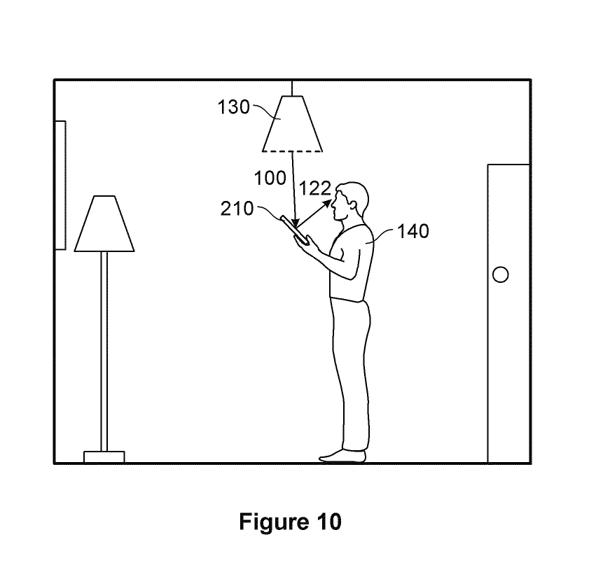

A “display with gain” can be one that can exhibit specular reflectance and characteristics in-between specular reflectance and Lambertian reflectance, e.g., light reflected into a range of angles less than 2π steradian. When such a display has a substantial directed component resulting in specular reflectance, there can be an opportunity for the display to “gain” brightness. If the light source is within some angular range off of the normal to the display surface, then the user may be able to take advantage of the gain. FIG. 10 illustrates an example of directed lighting 130 at a high angle and above the viewer 140. As shown in FIG. 10, the incoming light 100 from the directed lighting 130 illuminates the display 210 such that the incoming light 100 can reflect from the display 210 toward a direction 122. For portable displays such as in, e.g., cellular telephones, viewers naturally tend to hold the display 210 so that the directed light 122 is reflected toward their eyes, and the display 210 appears relatively bright. Thus, a display 210 with gain (or the directed lighting 130) can be adjusted such that the direction 122 of reflected light with the highest brightness is directed into the eyes of the viewer 140.

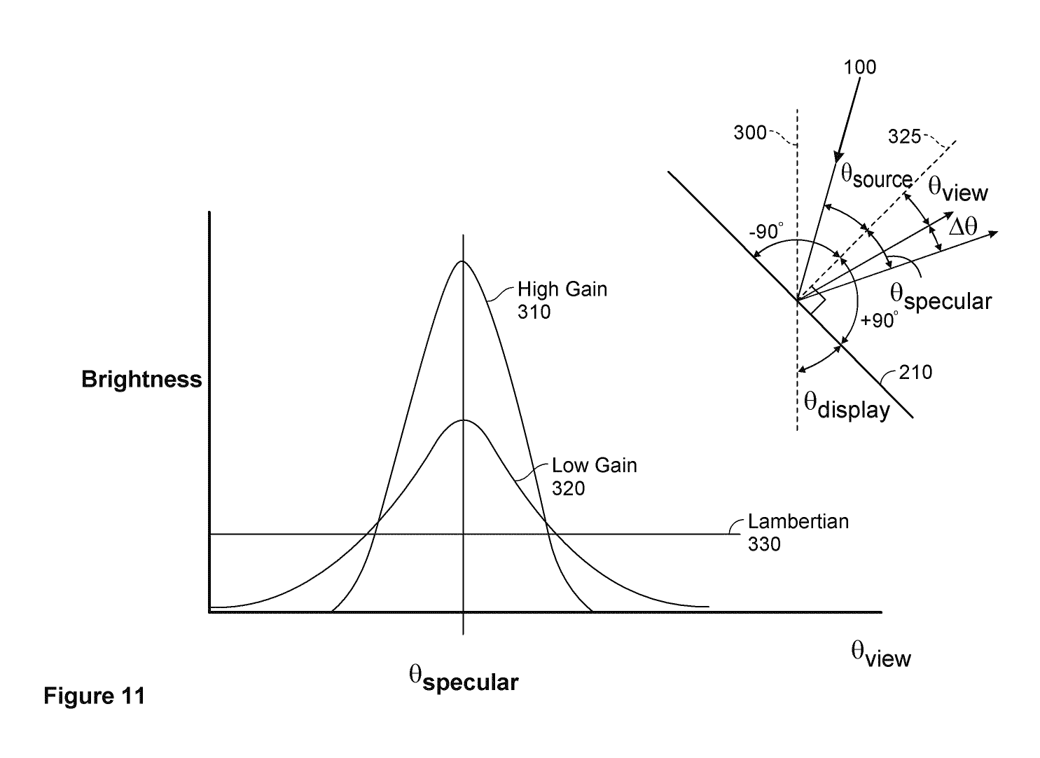

FIG. 11 is a graphical diagram of the brightness of a display as a function of the angle of view off the specular direction for examples of displays with high gain, low gain, and Lambertian characteristics. The angle of view can vary from about −90° to about +90° off the normal direction 325. The brightness of a display can be expressed as a luminance measured in units of candela/m² (sometimes called a “nit”). Trace 310 illustrates a display with relatively high gain, while trace 320 illustrates a display with relatively low gain. In these examples, the two traces 310 and 320 are bell shaped and can have maximum brightness at the angle of view, e.g., in a direction of specular reflection. The trace 310 illustrating relatively high gain has a maximum brightness that is larger than the trace 320 illustrating relatively low gain. As discussed above, a viewer 140 can adjust a display 210 with gain to take advantage of the maximum brightness by, e.g., orienting the display 210 so that the direction of maximum brightness (or a direction of brighter reflection) points toward the viewer's eyes. For example, the display 210 can be adjusted at an angle, θ_{display}, (e.g., measured relative to the vertical direction 300), to adjust the angle of view, θ_{view}, in relation to the angle, θ_{source}, of a light source 100. For example, in certain implementations, the angle, θ_{specular}, of specular reflection off the normal direction 325 can approximately equal the angle, θ_{source}, of a light source 100 off the normal direction 325. In these implementations, the angle of view off the specular direction, Δθ, can be expressed as θ_{specular}−θ_{view}. The brightness of the display 210 can be a function of the angle off the specular direction, Δθ, as shown, e.g., in FIG. 11.

Under conditions of high illuminance of diffuse lighting, e.g., a bright cloudy day, certain implementations of a reflective display 210 can appear relatively bright. Illuminance (in units of lux or lumens per square meter) is a measure of the luminous flux incident on a unit area of a surface. Under conditions of lower illuminance of diffuse lighting, e.g., a dark cloudy day, certain implementations of a reflective display can appear relatively dim. As discussed above, certain types of displays under diffuse lighting conditions can have Lambertian reflectance characteristics. As depicted in trace 330 in FIG. 11, the example display with Lambertian characteristics can appear substantially the same, e.g., has substantially the same brightness, even as the angle of view varies from about −90° to about +90°.

If the lighting is relatively uniform, some types of display 210 may not have the advantage of “gain” over a Lambertian display. In addition, because the light is spread in a wide range of directions under diffuse lighting conditions, for the same illuminance of light, a display illuminated with diffuse lighting may appear dimmer than when illuminated with directed lighting. Accordingly, various implementations of a display device may use the device and methods described herein to differentiate between illumination with diffuse lighting and with directed lighting to determine and control an additional amount of light that can be provided to the display device via an auxiliary light source, e.g., such as a front-light or back-light.

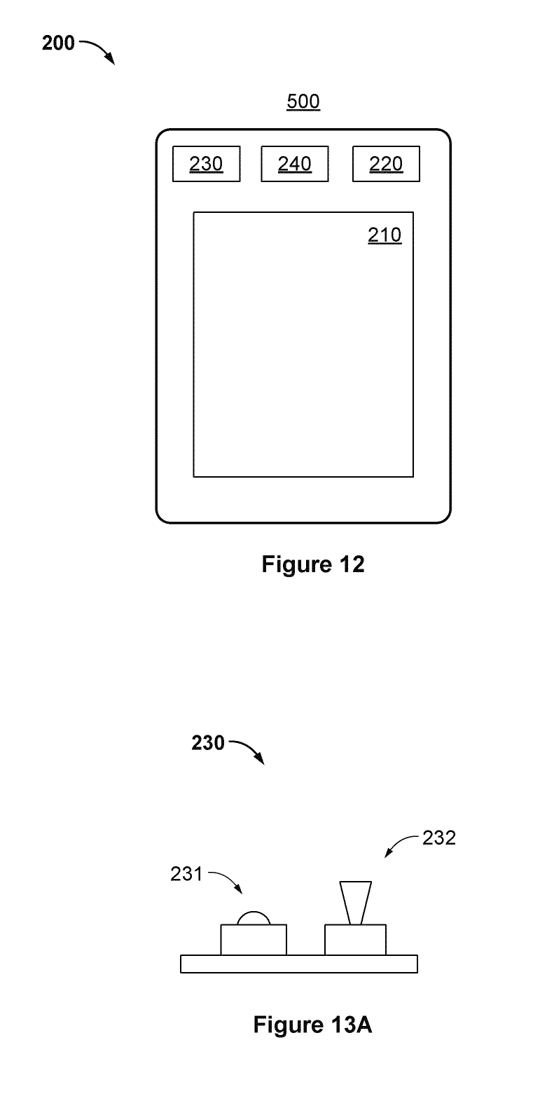

FIG. 12 illustrates an example implementation of a display device 200. The display device can include a display 210, and an auxiliary light source 220 configured to provide supplemental light to the display 210. The display device 200 further can include a sensor system 230 configured to measure illuminance of ambient light 500. The display device 200 further can include a controller 240 in communication with the sensor system 230. The controller 240, e.g. including control electronics, can be configured to adjust the auxiliary light source 220 to provide an amount of supplemental light to the display 210. The amount of supplemental light can be based at least in part on measurements from the sensor system 230.

In certain implementations, the display device 200 can include a display 210 such as those discussed herein, including displays for cellular telephones, mobile television receivers, wireless devices, smartphones, bluetooth devices, personal data assistants (PDAs), wireless electronic mail receivers, hand-held or portable computers, netbooks, notebooks, smartbooks, GPS receivers/navigators, cameras and camera view displays, MP3 players, camcorders, game consoles, wrist watches, clocks, calculators, electronic reading devices (e.g., e-readers), DVD players, CD players, or any electronic device. The shape of the display 210 can be, e.g., rectangular, but other shapes, such as square or oval also can be used. The display 210 can be made of glass, or plastic, or other material. In various implementations, the display 210 includes a reflective display, e.g., displays including reflective interferometric modulators as discussed herein or liquid crystal elements. In some other implementations, the display 210 includes a transflective display or an emissive display.

The display device 200 can include an auxiliary light source 220 configured to provide supplemental light to the display 210. In some implementations, the auxiliary light source 220 can include a front-light, e.g., for a reflective display. In some other implementations, the auxiliary light source 220 can include a back-light, e.g., for emissive or transflective displays. The auxiliary light source 220 can be any type of light source, e.g., a light emitting diode (LED). In some implementations, a light guide (not shown) can be used to receive light from the light source 220 and guide the light to one or more portions of the display 210.

In the implementation shown in FIG. 12, the sensor system 230 can be configured to measure a diffuse illuminance of the ambient light 500 from a wide range of directions and/or configured to measure a directed illuminance of the ambient light 500 from a relatively narrow range of directions. The diffuse illuminance can be a measure of the illuminance of the ambient light 500 arriving at the sensor system 230 from a wide range of angles, for example, light arriving at the display 210 from directions subtending a solid angle of up to about 2π steradians. The directed illuminance can be a measure of the illuminance of the ambient light 500 arriving at the sensor system 230 from directions subtending a solid angle less than 2π steradians, e.g., light arriving at the sensor system 230 from one or more relatively narrow cones of angles as will be described further below. In some implementations, the directed illuminance can be a measure of the illuminance of the ambient light 500 arriving at the sensor system 230 from directions subtending a solid angle much less than about 2π steradians. For example, in various implementations, the cone may have an angular (full) width in a range from about 5 degrees to about 60 degrees, e.g., about 5 degrees to about 15 degrees, from about 15 degrees to about 30 degrees, from about 30 to about 45 degrees, from about 45 degrees to about 60 degrees, or some other range of angular widths.

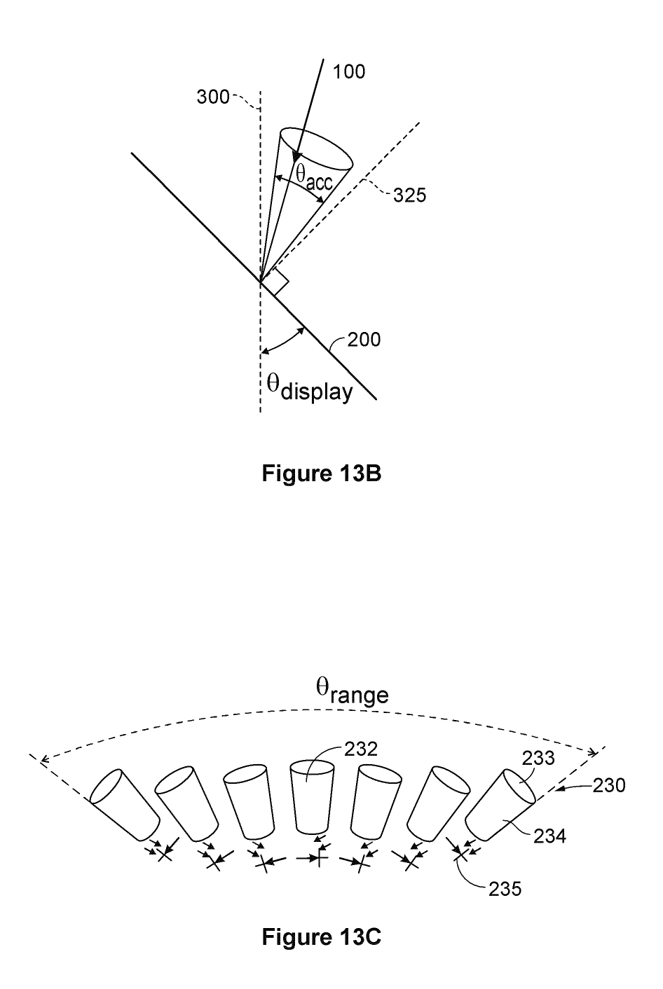

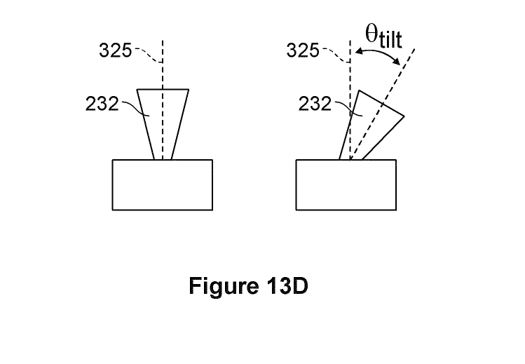

FIG. 13A illustrates an example sensor system 230 that includes a diffuse light sensor 231 and a directed light sensor 232. The diffuse light sensor 231 can be configured to measure the diffuse illuminance. In some implementations, the diffuse light sensor 231 can be an omnidirectional light sensor, e.g. an incidence meter, which senses light from a wide range of directions (e.g., light from substantially all directions incident on the sensor). The directed light sensor 232 can be configured to measure the directed illuminance. FIG. 13B illustrates an example of an acceptance angle, θ_{acc}, for an example directed light sensor 232. For example, the directed light sensor 232 may be sensitive to light coming from a direction within a cone having an acceptance angle, θ_{acc}, of, for example, about 10 degrees, about 15 degrees, about 20 degrees, about 25 degrees, about 30 degrees, about 35 degrees, about 40 degrees, about 45 degrees, about 50 degrees, about 55 degrees, about 60 degrees, or some other angle. The directed light sensor 232 can measure light received from a cone having an acceptance angle in a range from about 5 degrees to about 15 degrees, from about 15 degrees to about 30 degrees, from about 30 degrees to about 45 degrees, from about 45 degrees to about 60 degrees, or some other range of angular widths The sensor system 230 can include organic or nanoparticle sensors. The sensor system 230 also can include photodiodes, phototransistors, and/or photoresistors.

FIG. 13C illustrates an example sensor system 230 that includes a plurality of directed light sensors 232. Each of the directed light sensors 232 can point in a particular direction and can be sensitive to light received from a cone subtending a solid angle less than 2π steradians, and in some implementations much less than about 2π steradians. In some implementations, the directions of light sensitivity of one or more of the directed light sensors 232 may at least partially overlap, which may provide a degree of redundancy in case of failure of one of the sensors 232. In some other implementations, the directions of light sensitivity of one or more of the directed light sensors 232 may at least partially overlap to allow a measurement of the angular location of the directed light source through interpolation of measurements from two or more of the directed light sensors 232. In some implementations, the plurality of directed light sensors 232 can be arranged so that directed light sources disposed over a relatively wide range, θ_{range}, of angles relative to the directed light sensors 232 (e.g., up to about 2π steradians) can be measured. For example, the linear array of sensors 232 shown in FIG. 13C can measure directed light sources in a range, θ_{range}, of angles of up to about 120 degrees, up to about 140 degrees, or up to about 160 degrees along the line of the array. In some other implementations, the directed light sensors 232 can be arranged to be sensitive to directed light sources coming from expected or anticipated directions relative to the display device 200.

In some cases, each of the directed light sensors 232 may be sensitive to light coming from directions within a cone having an acceptance angle of, for example, about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, or some other angle. In other cases, the directed light sensors 232 may be sensitive to light coming from directions within a cone having different angles, e.g., one directed light sensor can be sensitive to about 40 degrees, while another directed light sensor can be sensitive to about 30 degrees. In some implementations, directed light sensors 232 with a narrower acceptance angle can be arranged at locations of anticipated directed illuminance. In some other implementations, directed light sensors 232 with a narrower acceptance angle can be arranged to overlap directed light sensors 232 with a wider acceptance angle to allow a measurement of the angular location of the directed light source through interpolation of measurements from the directed light sensor 232 with a narrower acceptance angle and the directed light sensor 232 with a wider acceptance angle. In some implementations, the plurality of directed light sensors 232 can be used with a diffuse sensor 231, for example, as shown in FIG. 13A. In some other implementations, the diffuse illuminance can be measured by the plurality of directed light sensors 232, for example, the average of the illuminances measured by each of the directed light sensors 232 weighted based on the respective angle of acceptance for each of the directed light sensors 232. In various implementations, the plurality of sensors 232 may be disposed in a linear array as shown in FIG. 13C or in a two-dimensional array (e.g., a 4×4or 5×5 array). The plurality of directed light sensors 232 can be formed in some implementations as a number of apertures 233 or a number of tubes 234 combined with photosensors 235 or a photosensor array. For example, an array of apertures 233 can be formed in a portion of the cover of the display device 200 and a photosensor 235 can be disposed below each of the apertures 233. An aperture 233 can be formed as an elongated opening pointing in a particular direction, and the size and/or opening angle of the aperture 233 can be used to limit reception of light (by the photosensor 235 or photosensor array) to a particular range of angles. Various implementations also can include a lens to limit the acceptance angle of an aperture 233.

FIG. 13D illustrates an example sensor system that includes a single directed light sensor 232. As shown on the left of FIG. 13D, the directed light sensor 232 can measure the directed illuminance in a first position. The directed light sensor 232 can tilt to collect light from multiple directions. For example, as shown on the right of FIG. 13D, the directed light sensor 232 can tilt to measure the directed illuminance in a second position. In various implementations, the directed light sensor 232 can tilt an angle, θₜᵢₗₜ, from about ±90 degrees from the normal direction 325. The directed illuminance can be measured by the directed light sensor 232 at different tilt angles, θₜᵢₗₜ. The diffuse illuminance also can be determined by the directed light sensor 232, for example, the average of the illuminances measured by the directed light sensor 232 for all of the measured illuminances weighted based on the respective angle of acceptance for each of different tilt angles, Sₜᵢₗₜ. The display device 200 may include an actuator (not shown) that can automatically tilt the sensor 232.

As shown in FIG. 12, the display device 200 can further include a controller 240 in communication with the sensor system 230. The controller 240, e.g. including control electronics, can be configured to adjust the auxiliary light source 220 based at least in part on the measured directed illuminance and/or the measured diffuse illuminance of the ambient light 500. In some implementations, the controller 240 can adjust the auxiliary light source 220 to substantially match the ambient light 500. The controller 240 in some implementations can enable closed loop behavior based on the sensor system 230 to further adjust the auxiliary light source 220.

An example method to determine a lighting condition based at least in part on the measured directed illuminance and the measured diffuse illuminance of the ambient light 500 can be based at least in part on the ratio of the measured directed light to the measured diffuse light and on the measured illuminance of ambient light (e.g., ambient illuminance measured in lux). The controller 240 can determine how much, if any, extra lighting is desired and can set the auxiliary light source 220 to the determined additional lighting amount.

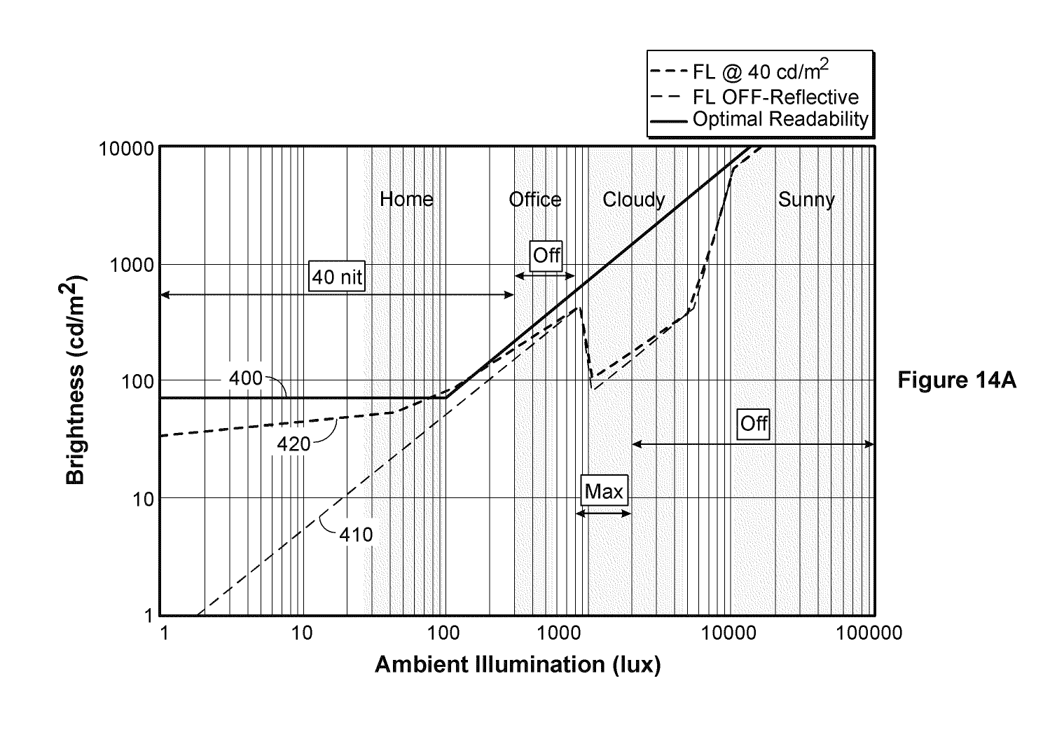

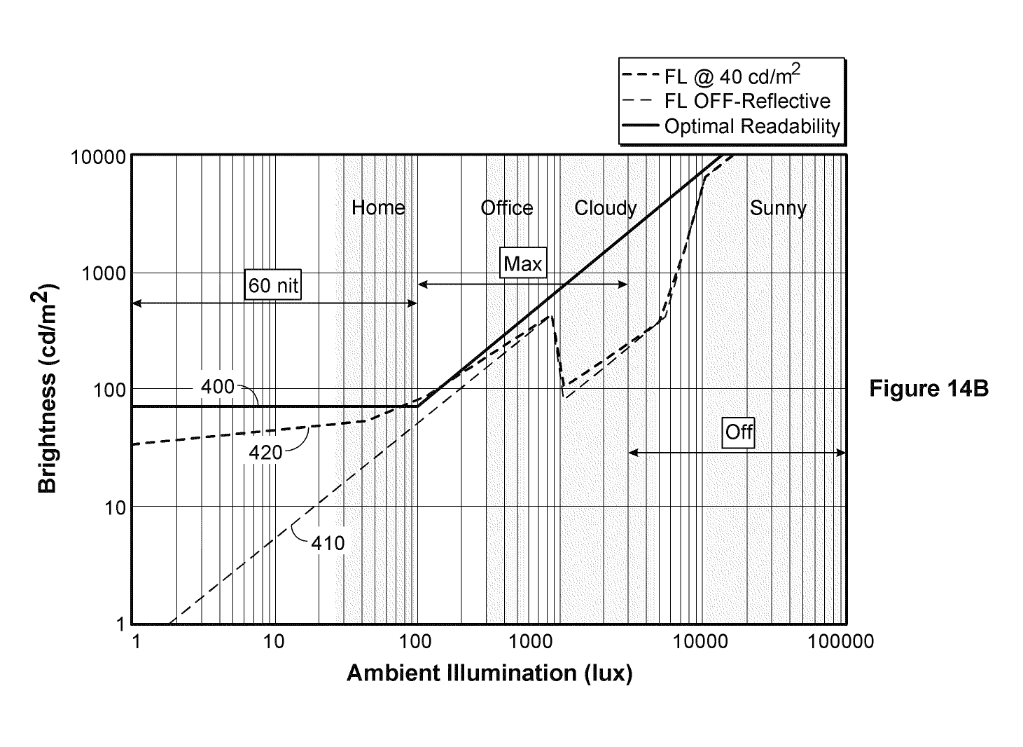

FIG. 14A shows example experimental results and an example illumination model for an example display device. The vertical axis is brightness of the display (measured in units of candela per square meter or “nits”), and the horizontal axis shows the conditions of ambient illumination (in units of lux or lumens per square meter). Trace 400 illustrates an estimate of the optimal readability, e.g., optimal visual acuity, for an example display device 200. Trace 410 illustrates the example display device 200 with the auxiliary light source set to zero. Trace 420 illustrates an example display device 200 with the auxiliary light source set at 40 nits. Under conditions of high illuminance, e.g., sunny and/or bright cloudy conditions, no additional lighting may be desired, so the auxiliary light source 220 can be set to zero (or a sufficiently small value). For conditions of less diffuse illuminance, e.g., dark cloudy conditions, additional lighting may be desired, so the auxiliary light source 220 can be set to a value up to or equal to the maximum amount of light that can be produced by the light source 220. For conditions of highly directed illuminance, e.g., an office environment, no additional lighting may be desired, so the auxiliary light source 220 can be set to zero (or a sufficiently small value). For conditions of less directed illuminance, e.g., home environment, additional lighting may be desired, so the auxiliary light source 220 can be set to a value sufficient to provide a display that is readily viewable under the ambient lighting conditions. As shown in FIG. 14A, by providing an amount of supplemental light to some implementations of the display device 200, the brightness of the display device 200 can approach the condition of optimal readability, e.g., trace 400. In the example illumination model shown in FIG. 14A, this value of supplemental illumination is 40 nits. The example supplemental illumination model shown in FIG. 14A may save energy because it can optimize between brightness and power usage. Thus, certain implementations can provide a sufficiently bright display under a wide range of ambient illumination conditions. In addition, the battery life for battery-powered display devices 200 may be prolonged.

FIG. 14B shows example experimental results and an example illumination model for an example reflective display device that appears relatively bright compared to a reflective display device without use of a front-light source. Similar to the example discussed with reference to FIG. 14A, under conditions of high illuminance, e.g., sunny and/or bright cloudy conditions, the auxiliary light source 220 can be set to zero (or a sufficiently small value) because little or no additional lighting may be desired. Also, similar to the example shown in FIG. 14A, under conditions of less diffuse illuminance, e.g., dark cloudy conditions, the auxiliary light source 220 can be set to a value up to or equal to the maximum amount of light that can be produced by the light source 220. For conditions of highly directed illuminance, e.g., office environments, additional lighting may be desired for a bright display, so the auxiliary light source 220 can be set to a value up to or equal to the maximum amount of light that can be produced by the light source 220. For conditions of less directed illuminance, e.g., home environments, more additional lighting may also be desired, so the auxiliary light source 220 can be set to a higher value, e.g., 60 nits, than determined for the display of FIG. 14A. Because the display device of FIG. 14B can use more supplemental light than the display device of FIG. 14A, the display device of FIG. 14B can appear brighter than the display device of FIG. 14A. However, by using less supplemental light, the display device of FIG. 14A can consume less power, save energy, and have prolonged battery life as compared to the display device of FIG. 14B. The example auxiliary illumination models described with reference to FIGS. 14A and 14B are intended as illustrative and not limiting. In some other implementations of the display device 200, other auxiliary illumination models can be used.

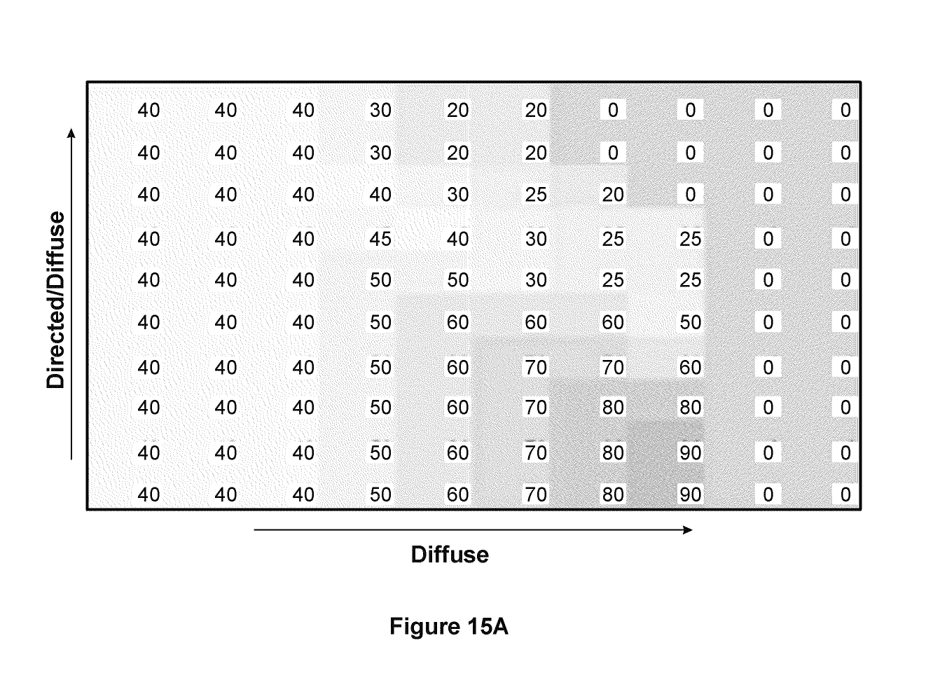

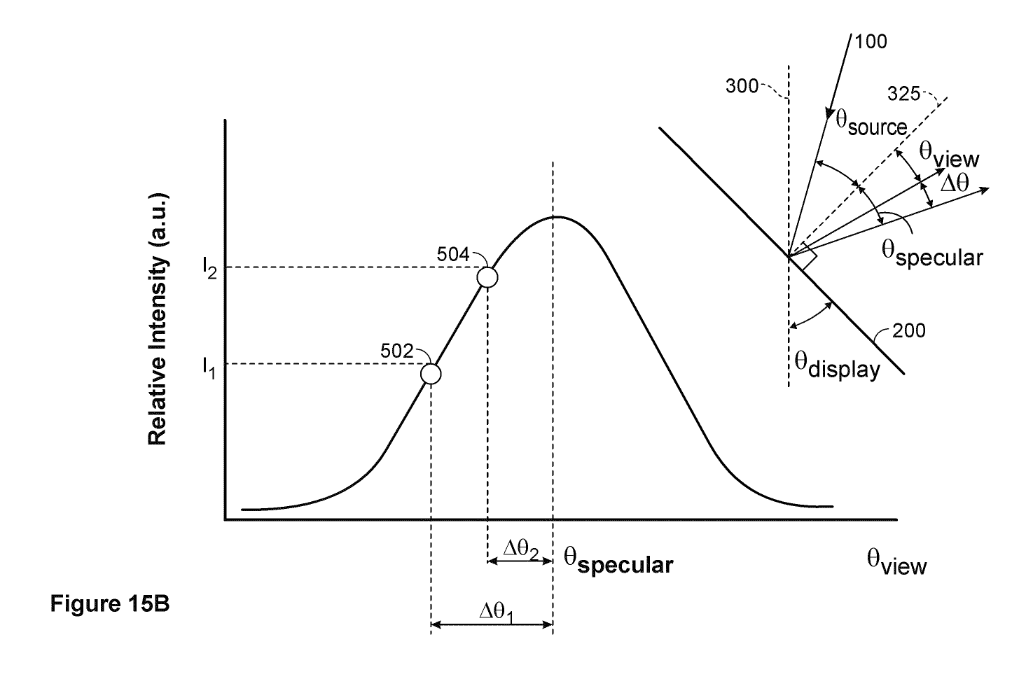

FIG. 15A illustrates an example lookup table that can be used in some implementations to determine an amount of supplemental light to add to a display device 200. A lookup table can be generated in some implementations based at least in part on experimental data, e.g., FIGS. 14A and 14B. The x-coordinate of the lookup table can represent the illuminance of the ambient light (e.g., the illuminance of the diffuse component of the ambient light). The y-coordinate can represent the ratio of the amount of directed light to the amount of diffuse light. The value in the example lookup table at any x-y coordinate is the amount of auxiliary light to be added to the display (in nits). In this example, extra lighting may be desired for very low illuminance ambient light (represented by “40” within the lookup table, e.g., home environments), while not desired for very high illuminance ambient light irrespective of the ratio of directed light to diffuse light (represented by “0” within the lookup table, e.g., sunny conditions or office environments for an efficient display). In between these two extremes, for the same illuminance conditions (e.g., lux) of ambient light, it may be desired to have more additional light when the display device 200 is illuminated with a lower ratio of directed light to diffuse light than with a higher ratio of directed light to diffuse light (represented by higher values at the bottom of the table, e.g., dark cloudy conditions, compared to lower values at the top of the table, e.g., home environments).

In certain implementations, a diffuse sensor 231 can measure the diffuse illuminance, e.g., the x-coordinate. A directed sensor 232 can measure the directed illuminance. Using the measured diffuse illuminance and the measured directed illuminance, the controller 240 can determine a ratio of the measured directed illuminance to the measured diffuse illuminance, e.g., the y-coordinate. The controller 240 may then use a lookup table that may be generally similar to the one described above to determine how much auxiliary light to add to the display device 200 based at least in part on the amount of ambient light (e.g., diffuse illuminance) and the ratio of directed light to diffuse ambient light (e.g., proportion of directed illuminance to diffuse illuminance).

In some other implementations, the controller 240 may use a formula (or algorithm) to determine how to adjust the auxiliary light source 220 of the display device 200. For example, the amount of diffuse light and the amount of directed light may be some of the inputs to the formula. In some implementations, the formula may also depend on the measured (or estimated or assumed) position(s) of some or all of the directed light source(s). The formula may result in adjusted auxiliary light levels very similar or identical to those illustrated in FIG. 15A, or different.

FIG. 15B is a graphical diagram of the relative intensity (in arbitrary units) as a function of the angle of view off the specular direction for a display device with gain. As described above, the angle off the specular direction, Δθ, can be expressed as θ_{specular}−θ_{view}. In some displays with gain, a directed light source positioned at a larger angle off the specular (e.g., with larger Δθ) may tend to contribute less relative intensity to a viewer than a directed light source positioned at a smaller angle off the specular (e.g., with smaller Δθ). FIG. 15B illustrates an example in which there are two directed light sources 502 and 504. In other examples, a different number of directed light sources may be present such as, e.g., none, one, three, or more. The directed light source 502 positioned at Δθ₁ off the specular direction has an intensity of I₁, and the directed light source 504 positioned at Δθ₂ off the specular has an intensity of I₂, which is larger than I₁ in this example because Δθ₂<Δθ₁. In the example shown in FIG. 15B, the intensity, I, of the display device 200 as observed by a viewer can be expressed as the sum of I₁, I₂, and I_{diffuse}, where I_{diffuse} is the intensity of the diffuse illuminance.

In some implementations, a general formula for determining the intensity I of the display device 200 with Nₛ directed light sources can be expressed as

$$I = {\sum }_{k = 1}^{{N}_{s}} {I}_{k} ( {Δθ}_{k} ) + {I}_{diffuse} , \qquad ( 1 )$$

where Iₖ(Δθₖ) is the intensity from each of the Nₛ directed light sources located at angles Δθₖ. The intensity Iₖ may be generally similar to the example intensity curves shown in FIGS. 11 and 15B, in various implementations. The summation on the right hand side of this equation can be an estimate of the total directed illumination, I_{directed}. By determining how bright the display device 200 appears (e.g., the intensity I), the amount of desired supplemental light can be determined, in various implementations, based at least in part on one or more of: I, I_{directed}, I_{diffuse}, I_{directed}/I_{diffuse}, and so forth.

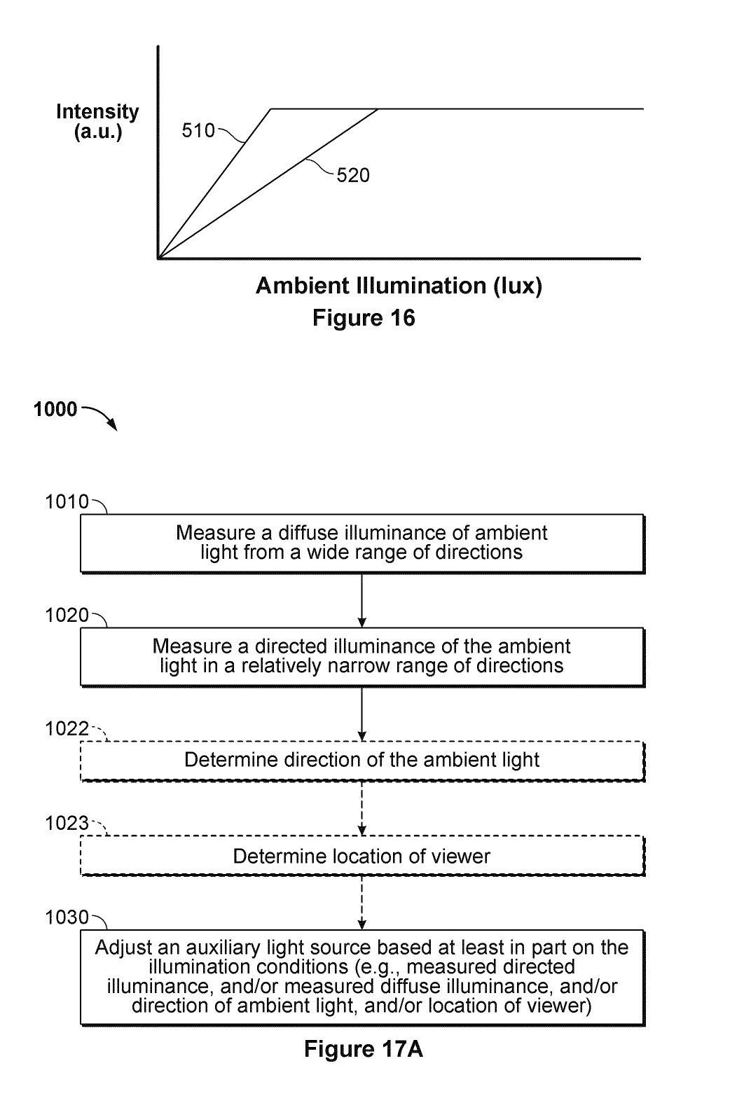

Although the above examples provide a lookup table and formula for an example of a reflective display (e.g., additional lighting for ambient light with low illuminance), a lookup table and/or formula can be provided for emissive or transflective displays. For example, although an emissive LCD may use a back-light as a light source, if ambient light reflects into a viewer's eyes, a lookup table or formula can provide how to adjust the back-light to keep the contrast low, e.g., how much additional light to increase to the display when the ambient light has high illuminance or how much light to decrease from the display when the ambient light has low illuminance. FIG. 16 illustrates two example illumination models for an emissive display device. Trace 510 and trace 520 represent two responses of the total backlight intensity (in arbitrary units) as a function of ambient illumination (measured in lux) for an emissive display device. In these examples, as the ambient illumination increases, the intensity of the backlight can be adjusted to increase the intensity of the display until the maximum value of the backlight is reached. Trace 510 represents a higher glare situation where the contrast is higher than the glare situation represented by trace 520. To overcome the higher glare, the backlight of the emissive display can be increased at a faster rate (e.g., following trace 510) than for the lower glare situation (e.g., following trace 520). By determining how bright the display device appears, the backlight can be adjusted to increase light to or decrease light from the display.

When a directed ambient light source is near the display device 200, various implementations can locate the direction of the ambient light source by finding or estimating the direction of the brightest source of directed light. For example, the display device 200 can locate the direction of the ambient light source by weighing the illuminances of the light detected by the directed light sensor 232 coming from the different directions. For example, the direction may be determined as an estimated angle to the directed light source (e.g., measured via the example linear array shown in FIG. 13C) or as a pair of estimated angles (e.g., an altitude angle and azimuth angle relative to a 2-D sensor array). Based at least in part on the ratio of directed light to diffuse light, the illuminance of ambient light, and the direction of the directed light source, the controller 240 can be configured to adjust the auxiliary light source 220.

In yet another implementation, the display device 220 can determine the location of the presumed viewer when a directed light source is present. This implementation can include a back facing low-resolution camera (e.g., a wide-angle lens configured to image light onto a low resolution image sensor array) to determine the location of the viewer. The two-dimensional array of directed light sensors 232 as shown in FIG. 13C (which can act like a low-resolution camera) also can be used to detect viewer direction. For example, in some implementations, the viewer can be assumed to be a few degrees from normal relative to the display and tipped slightly backwards. In some implementations, the low-resolution camera can locate the viewer by locating a “dark spot” in front of the display, caused by the viewer blocking some of the ambient light from that direction.

In some cases, the controller 240 may assume the viewer has dynamically adjusted the display device 200 to the optimum (or close to the optimum) position so that the directed light source(s) reflect toward the viewer's eyes (e.g., by manually orienting the display in the viewer's hand). As shown in FIGS. 11 and 15B, the display device 200 can be adjusted at an angle, θ_{display}, (e.g., measured relative to the vertical direction 300), to adjust the angle of view, θ_{view}, in relation to the angle of a light source 100. In some implementations, the angle, θ_{display}, of the display 200 can be assumed to be at about 45 degrees, or between about 43 degrees and about 47 degrees, or between about 40 degrees and about 50 degrees, or between about 35 degrees and about 55 degrees from the vertical position 300. When used indoors, the brightest angle of view can be assumed to be between about 15 degrees and about 30 degrees, or between about 17 degrees and about 28 degrees, or between about 20 degrees and about 25 degrees off the normal direction 325. When used outdoors, the brightest angle of view can be assumed to be between about 30 degrees and about 45 degrees, or between about 33 degrees and about 43 degrees, or between about 35 degrees and about 40 degrees off the normal direction 325. As shown in FIG. 13B, the acceptance angle, θ_{acc}, for an example sensor system 230 can vary based on the direction of the display device 200. For example, if the angle of the display device 200, θ_{display}, is at about a 45° angle from the vertical position 300, the acceptance angle, θ_{acc}, for the sensor system can be about 40°.

Based, at least in part, on the ratio of directed light to diffuse light, the illuminance of ambient light, the direction(s) to the directed light source(s), and on the presumed, estimated, or measured location of the viewer with respect to the location of the directed light source(s), the controller 240 can be configured to adjust the auxiliary light source 220 accordingly. For example, as described above, some implementations may use formula (1) to determine the total, directed, and diffuse intensities.

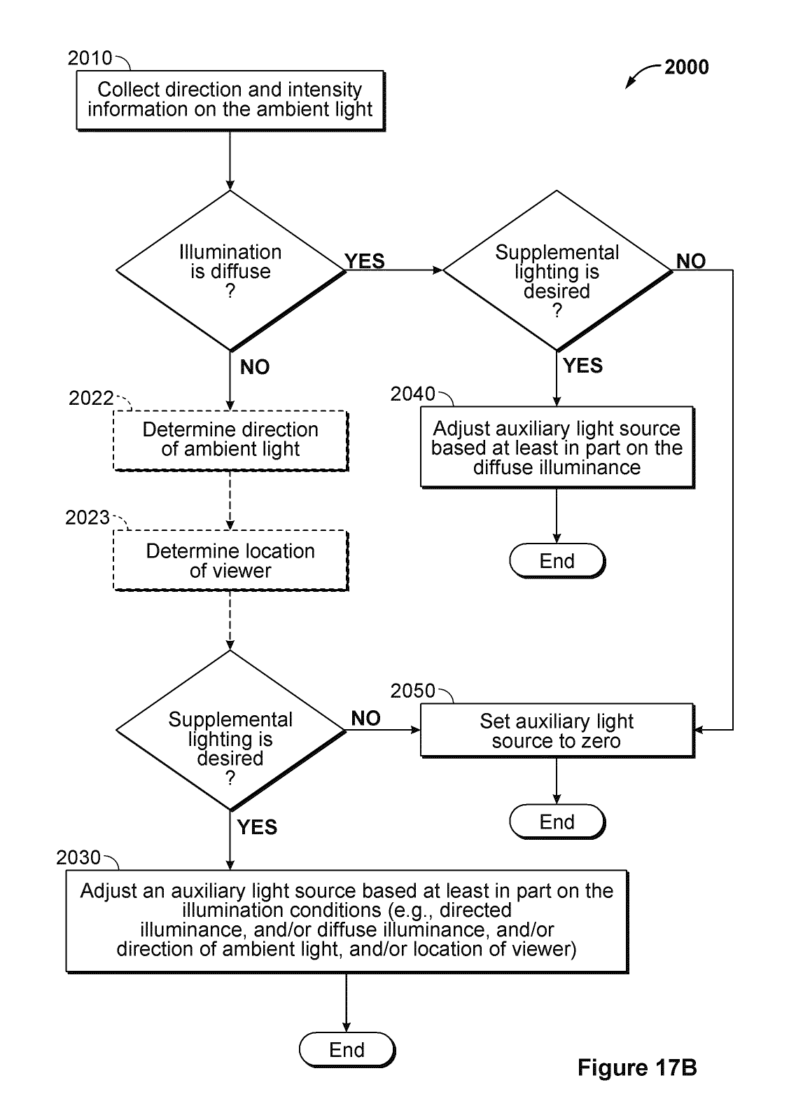

FIG. 17A illustrates an example method of controlling lighting of a display. In FIG. 17A, the method 1000 is compatible with various implementations of the display device 200 described herein. For example, the method 1000 can be implemented by the controller 240. The method 1000 includes measuring a diffuse illuminance of ambient light 500 from a wide range of directions as shown in block 1010. For example, the diffuse light sensor 231 can be used to make the measurement described in block 1010. The method 1000 further includes measuring a directed illuminance of the ambient light 500 from a relatively narrow range of directions as shown in block 1020. For example, the directed light sensor 232 can be used to make the measurement described in block 1020. As shown in block 1030, the method 1000 further includes adjusting an auxiliary light source 220 based at least in part on the illumination conditions (e.g., measured directed illuminance and/or the measured diffuse illuminance of the ambient light 500). For example, in some implementations, the controller 240 can determine additional lighting conditions based at least in part on the measurement of the directed illuminance and the measurement of the diffuse illuminance of the ambient light. The controller 240 can receive the measurements of the directed and diffuse illumances from a computer-readable storage medium (e.g., a memory device in communication with the controller). The controller 240 can transmit a lighting adjustment to the light source 220 configured to provide light to the display 210. The lighting adjustment can be based at least in part on the additional lighting conditions determined by the controller 240. For example, the lighting adjustment may include an amount by which the illumination provided by the light source 220 is to be increased or decreased. In some implementations, the controller 240 may transmit the additional lighting conditions to a lighting controller configured to adjust the light source 220.

In some implementations, adjusting the auxiliary light source 220 is based at least in part on a ratio of the measured directed illuminance to the measured diffuse illuminance. As shown in FIG. 17A, the method 1000 also can include determining a direction of the ambient light 500 as shown in optional block 1022. Also as shown in FIG. 17A, the method 1000 also can include determining a location of the viewer of the display 210 as shown in optional block 1023. Thus, adjusting the auxiliary light source 220 as shown in block 1030 also can be based on a direction to a directed ambient light source and/or on a location of a viewer.

FIG. 17B illustrates another example method of controlling lighting of a display. The example method 2000 can be executed by the controller 240. As shown in block 2010, the method 2000 can include collecting direction and intensity information on the ambient light 500. Collecting direction and intensity information on the ambient light 500 can include collecting measured diffuse illuminance of ambient light 500 from a wide range of directions, e.g., as described in block 1010 of FIG. 17A. Collection of direction and intensity information on the ambient light 500 also can include collecting the measured directed illuminance of the ambient light 500 in a relatively narrow range of directions, e.g., as described in block 1020 of FIG. 17A. If the illumination of ambient light 500 is substantially diffuse, the brightness of the display surface may look substantially the same in all directions above the display surface (e.g., displaying Lambertian reflectance characteristics). If supplemental light is desired, some implementations of the method can include adjusting an auxiliary light source 220 based at least in part on the diffuse illuminance as shown in block 2040. On the other hand, if supplemental light is not desired, some implementations can include setting the auxiliary light source to zero (or a sufficiently small value) as shown in block 2050.

If the illumination of ambient light 500 has a directed component, the display may exhibit specular reflectance and characteristics in-between specular reflectance and Lambertian reflectance, e.g., a display with gain. If supplemental light is desired, some implementations of the method can include adjusting an auxiliary light source 220 based at least in part on the directed illuminance and/or the diffuse illuminance of the ambient light as shown in block 2030. On the other hand, if supplemental light is not desired, some implementations can include setting the auxiliary light source 220 to zero (or a sufficiently small value) as shown in block 2050. In some implementations, the method 2000 also can include determining a direction of the ambient light 500 as shown in optional block 2022. In these implementations, adjusting the auxiliary light source 220 in block 2030 also can be based on the direction of the ambient light 500. In some implementations, the method 2000 can include determining a location of the viewer as shown in optional block 2023. In these implementations, adjusting the auxiliary light source 220 in block 2030 also can be based on the assumed, estimated, or measured location of the viewer.

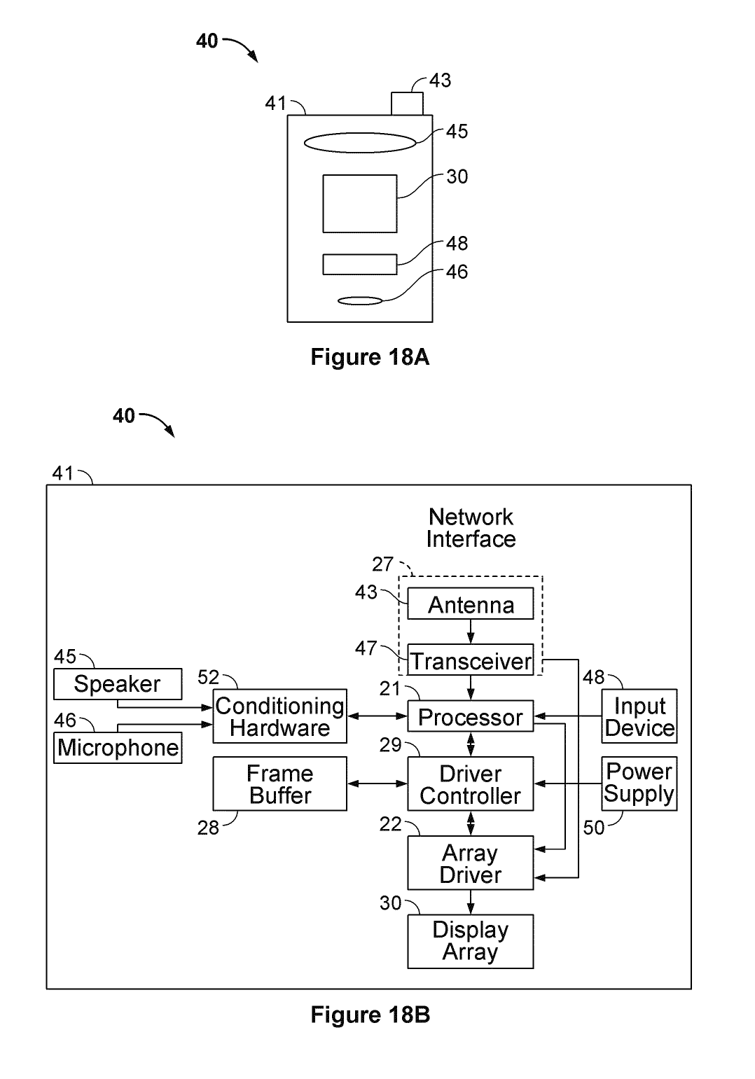

FIGS. 18A and 18B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players. The display device 200 (and components thereof) described with reference to FIG. 12 may be generally similar to the display device 40.

The display device 40 includes a housing 41, a display 30, an antenna 43, a speaker 45, an input device 48, and a microphone 46. The display 30 can include the various examples of the display 210 as described herein. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols. As described herein, the housing 41 can include at least one aperture or tube combined with a photosensor to form a directed light sensor. The housing 41 also can include a plurality of apertures or tubes combined with photosensors to form a plurality of directed light sensors.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 18B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. In certain implementations, the processor 21 can include the controller 240 or can function as the controller 240 described herein. Methods described herein, e.g., methods 1000 and 2000, can be executed via instructions by the processor 21. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, a central processing unit (CPU), or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the lookup table, functions or formulas used to produce or use the lookup table or to produce values for the amount of auxiliary light may be stored on or transmitted over as one or more data structures or instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
a display;
an auxiliary light source configured to provide supplemental light to the display;
a sensor system configured to measure:
a diffuse illuminance of ambient light from a wide range of directions; and
a directed illuminance of the ambient light from a relatively narrow range of directions; and
a controller in communication with the sensor system, the controller configured to adjust the auxiliary light source to provide an amount of supplemental light to the display, the amount of supplemental light based at least in part on the measured directed illuminance and the measured diffuse illuminance of the ambient light.

2. The display device of claim 1, wherein the display includes a reflective display.

3. The display device of claim 2, wherein the reflective display includes interferometric modulators.

4. The display device of claim 1, wherein the sensor system includes at least one sensor configured to sense ambient light from at least two directions.

5. The display device of claim 4, wherein the at least one sensor includes a diffuse light sensor configured to measure the diffuse illuminance and a directed light sensor configured to measure the directed illuminance.

6. The display device of claim 4, wherein the at least one sensor includes a plurality of directed light sensors, each directed light sensor configured to measure illuminance of the ambient light received within a solid angle around a direction, the solid angle substantially less than 2π steradians

7. The display device of claim 1, wherein the controller is configured to adjust the auxiliary light source based at least in part on a ratio of the measured directed illuminance to the measured diffuse illuminance.

8. The display device of claim 1, wherein the controller is configured to adjust the auxiliary light source based at least in part on a sum of the measured directed illuminances and the measured diffuse illuminance.

9. The display device of claim 1, wherein the controller is configured to adjust the auxiliary light source based on a direction to a directed ambient light source.

10. The display device of claim 9, wherein the direction to the directed ambient light source is determined based at least in part on the directed illuminance and the diffuse illuminance measured by the sensor system.

11. The display device of claim 10, wherein the controller is configured to adjust the auxiliary light source based at least in part on a location of a viewer.

12. The display device of claim 1, further comprising:
a processor that is configured to communicate with the display, the processor being configured to process image data; and
a memory device configured to communicate with the processor.

13. The display device of claim 12, further comprising:
a driver circuit configured to send at least one signal to the display.

14. The display device of claim 13, further comprising:
a driver controller configured to send at least a portion of the image data to the driver circuit.

15. The display device of claim 12, further comprising:
an image source module configured to send the image data to the processor.

16. The display device of claim 15, wherein the image source module includes at least one of a receiver, transceiver, and transmitter.

17. The display device of claim 12, further comprising:
an input device configured to receive input data and to communicate the input data to the processor.

18. A display device comprising:
a display;
an auxiliary light source;
means for sensing ambient light, the means for sensing ambient light configured to measure a diffuse illuminance of the ambient light from a wide range of directions and configured to measure a directed illuminance of the ambient light from a relatively narrow range of directions; and
a controller in communication with the means for sensing ambient light, the controller configured to adjust the auxiliary light source based at least in part on the measured directed illuminance and the measured diffuse illuminance of the ambient light.

19. The display device of claim 18, wherein the display includes a reflective display.

20. The display device of claim 19, wherein the reflective display includes interferometric modulators.

21. The display device of claim 18, wherein the auxiliary light source includes a front-light.

22. The display device of claim 18, wherein the means for sensing ambient light includes at least one sensor configured to sense ambient light from at least two directions.

23. The display device of claim 22, wherein the at least one sensor includes a diffuse light sensor configured to measure the diffuse illuminance and a directed light sensor configured to measure the directed illuminance.

24. The display device of claim 22, wherein the at least one sensor includes a plurality of directed light sensors, each directed light sensor configured to measure illuminance of the ambient light received within a solid angle around a direction, the solid angle substantially less than 2π steradians.

25. The display device of claim 18, wherein the controller is configured to adjust the auxiliary light source based at least in part on a ratio of the measured directed illuminance to the measured diffuse illuminance.

26. The display device of claim 18, wherein the controller is configured to adjust the auxiliary light source based at least in part on a sum of the measured directed illuminances and the measured diffuse illuminance.

27. The display device of claim 18, wherein the controller is configured to adjust the auxiliary light source based on a direction to a directed ambient light source.

28. The display device of claim 27, wherein the controller is configured to adjust the auxiliary light source based on a location of a viewer.

29. A method of controlling lighting of a display of a display device, the display device having an auxiliary light source configured to provide supplemental light to the display, the display device having a diffuse light sensor and a directed light sensor, the method comprising:
measuring, via the diffuse light sensor, a diffuse illuminance of ambient light from a wide range of directions;
measuring, via the directed light sensor, a directed illuminance of the ambient light from a relatively narrow range of directions; and
adjusting, via execution of instructions by a hardware processor, the auxiliary light source based at least in part on the measured directed illuminance and the measured diffuse illuminance of the ambient light.

30. The method of claim 29, wherein adjusting the auxiliary light source includes adjusting the auxiliary light source based at least in part on a ratio of the measured directed illuminance to the measured diffuse illuminance.

31. The method of claim 29, wherein adjusting the auxiliary light source includes adjusting the auxiliary light source based at least in part on a sum of the measured directed illuminances and the measured diffuse illuminance.

32. The method of claim 29, wherein adjusting the auxiliary light source is based on a direction to a directed ambient light source.

33. The method of claim 32, wherein adjusting the auxiliary light source is based on a location of a viewer.

34. A non-transitory tangible computer storage medium having stored thereon instructions for controlling lighting of a display of a display device, the instructions, when executed by a computing system, causing the computing system to perform operations comprising:
receiving from a computer-readable medium a measurement of a directed illuminance of ambient light from a relatively narrow range of directions;
receiving from a computer-readable medium a measurement of a diffuse illuminance of ambient light from a wide range of directions;
determining additional lighting conditions based at least in part on the measurement of the directed illuminance and the measurement of the diffuse illuminance of the ambient light; and
transmitting a lighting adjustment based at least in part on the additional lighting conditions to a light source configured to provide light to the display.

35. The non-transitory tangible computer storage medium of claim 34, wherein receiving the diffuse illuminance of ambient light includes receiving a plurality of directed illuminances for different directions.

36. The non-transitory tangible computer storage medium of claim 34, wherein determining additional lighting conditions includes accessing a lookup table that correlates diffuse illuminance with a ratio of directed illuminance to the diffuse illuminance.

37. The non-transitory tangible computer storage medium of claim 34, wherein determining additional lighting conditions includes accessing a formula that correlates diffuse illuminance with a ratio of directed illuminance to the diffuse illuminance.

38. The non-transitory tangible computer storage medium of claim 34, wherein determining additional lighting conditions includes accessing a formula that is based at least in part on a sum of the measured directed illuminances and the measured diffuse illuminance.
